(19) United States
(12) Patent Application Publication
(10) Pub. No.: US 2012/0044241 A1
(43) Pub. Date: Feb. 23, 2012

(54) THREE-DIMENSIONAL ON-SCREEN DISPLAY IMAGING SYSTEM AND METHOD

(75) Inventors: CHUN-YU CHEN, TAINAN (TW); TZUNG-REN WANG, TAINAN (TW)

(73) Assignee: HIMAX TECHNOLOGIES LIMITED, TAINAN (TW)

(21) Appl. No.: 12/860,815

(22) Filed: Aug. 20, 2010

(51) Int. Cl. G06T 15/00

(52) U.S. Cl. 345/419

(57) ABSTRACT

The present invention is directed to a 3D OSD imaging system and method. A depth generator generates at least one image depth map according to a 2D image, and an image mixer superimposes an OSD image on the 2D image, thereby resulting in a 2D image with OSD. An OSD unit provides an OSD depth map and the OSD image, and a depth mixer superimposes the OSD depth map on the image depth map, thereby resulting in a composite depth map. A depth-image-based rendering (DIBR) unit generates a left image and a right image according to the 2D image with OSD and the composite depth map.

### BACKGROUND OF THE INVENTION

1. Field of the Invention

The present invention generally relates to digital image processing, and more particularly to a three-dimensional (3D) on-screen display (OSD) imaging system and method.

2. Description of Related Art

When three-dimensional (3D) objects are mapped onto a two-dimensional (2D) image plane by prospective projection, such as an image taken by a still camera or a video camera, a lot of information, particularly 3D depth information, disappears. A 3D imaging system, however, can convey 3D information to a viewer by recording 3D visual information or by re-creating the illusion of depth. Although the 3D imaging technique has been known for over a century, the 3D display becomes more practical and popular owing to availability of high-resolution and low-price displays such as liquid crystal displays (LCDs).

FIG. 1A shows a block diagram of a conventional 2D-to-3D imaging system 1, which is capable of displaying on-screen display (OSD). A depth generator 10 creates depth information according to an original 2D image. The depth information is then processed by a depth-image-based rendering (DIBR) unit 12 to generate a left (L) image and a right (R) image. An OSD unit 14 is used to superimpose OSD on the left image and right image respectively, therefore resulting in a left image with OSD and a right image with OSD. Specifically speaking, the OSD unit 14, at first, calculates binocular disparity between the left image and the right image, followed by superimposing the OSD on the left image and right image respectively. FIG. 1B schematically shows a left image with OSD 140L and a right image with OSD 140R. It is noted that the OSDs 140L/140R are superimposed on the left image and the right image with distinct disparity. For example, the OSD 140L superimposed on the left image has a position slightly shifted to the left, while the OSD 140R superimposed on the right image has a position slightly shifted to the right.

The conventional 2D-to-3D imaging system requires an effort (and associated cost) to calculate the binocular disparity. Further, while superimposing the OSD, the left image and the right image need be distinctly and respectively processed based on the calculated disparity. This leads to inefficient and inflexible performance for the conventional 3D imaging system. Accordingly, a need has arisen to propose a novel 3D OSD imaging system with more efficient and flexible scheme.

### SUMMARY OF THE INVENTION

In view of the foregoing, it is an object of the embodiment of the present invention to provide a 3D OSD imaging system and method that are capable of generating the left image and the right image to be displayed on a 3D display in an efficient and cost-effective way, and are capable of flexibly setting the depth of the OSD region or regions.

According to one embodiment, a three-dimensional (3D) on-screen display (OSD) imaging system includes a depth generator, an image mixer, an OSD unit, a depth mixer and a depth-image-based rendering (DIBR) unit. The depth generator generates at least one image depth map according to a two-dimensional (2D) image. The image mixer superimposes an OSD image on the 2D image, thereby resulting in a 2D image with OSD, wherein the OSD image includes at least one OSD region. The OSD unit provides an OSD depth map and the OSD image. The depth mixer superimposes the OSD depth map on the image depth map, thereby resulting in a composite depth map. The DIBR unit generates a left image and a right image according to the 2D image with OSD and the composite depth map.

### BRIEF DESCRIPTION OF THE DRAWINGS

FIG. 1A shows a block diagram of a conventional 2D-to-3D imaging system;

FIG. 1B schematically shows a left image with OSD and a right image with on-screen display (OSD);

FIG. 2 shows a block diagram that illustrates a 3D OSD imaging system according to one embodiment of the present invention;

FIG. 3 shows a flow diagram that illustrates a 3D OSD imaging method according to one embodiment of the present invention;

FIG. 4A through FIG. 4D show some exemplary OSD depth maps; and

FIG. 5 shows an exemplary OSD region including two objects.

### DETAILED DESCRIPTION OF THE INVENTION

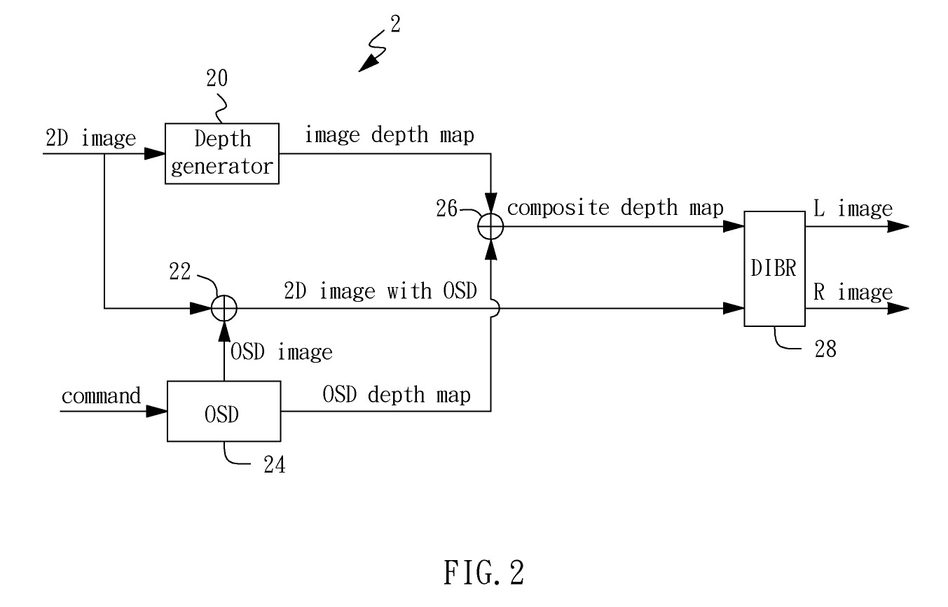

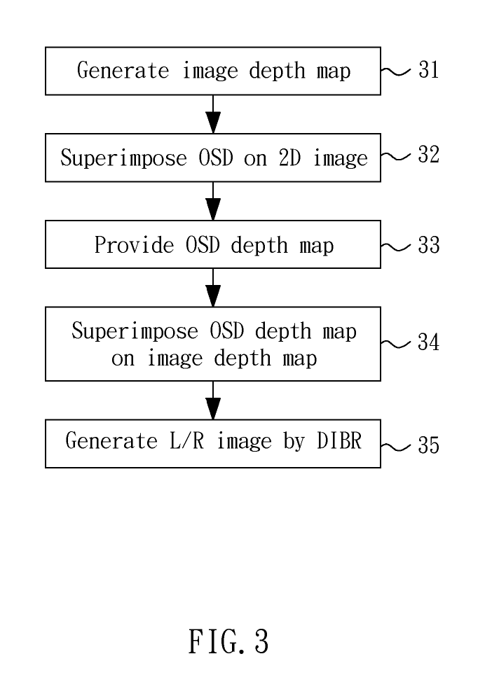

FIG. 2 shows a block diagram that illustrates a three-dimensional (3D) on-screen display (OSD) imaging system 2 according to one embodiment of the present invention. FIG. 3 shows a flow diagram that illustrates a 3D OSD imaging method according to one embodiment of the present invention.

In the embodiment, the 3D OSD imaging system 2 includes a depth generator 20 that receives an original two-dimensional (2D) image and then accordingly generates at least one image depth map (step 31). In the depth map, each pixel or block of pixels has a corresponding depth value. For example, an object near a viewer has a greater depth value (or greater brightness value) than an object far from the viewer.

The 3D OSD imaging system 2 also includes an image mixer 22 that receives the original 2D image and an OSD image provided by an OSD unit 24. The image mixer 22 then superimposes the OSD image on the original 2D image, therefore resulting in a 2D image with OSD (step 32). The OSD unit 24 provides the OSD image, for example, whenever a command is issued by a user or a host device such as a computer. The command controls an on/off status to turn on or turn off the display of the OSD. It is noted that the OSD image may include single OSD region or multiple OSD regions.

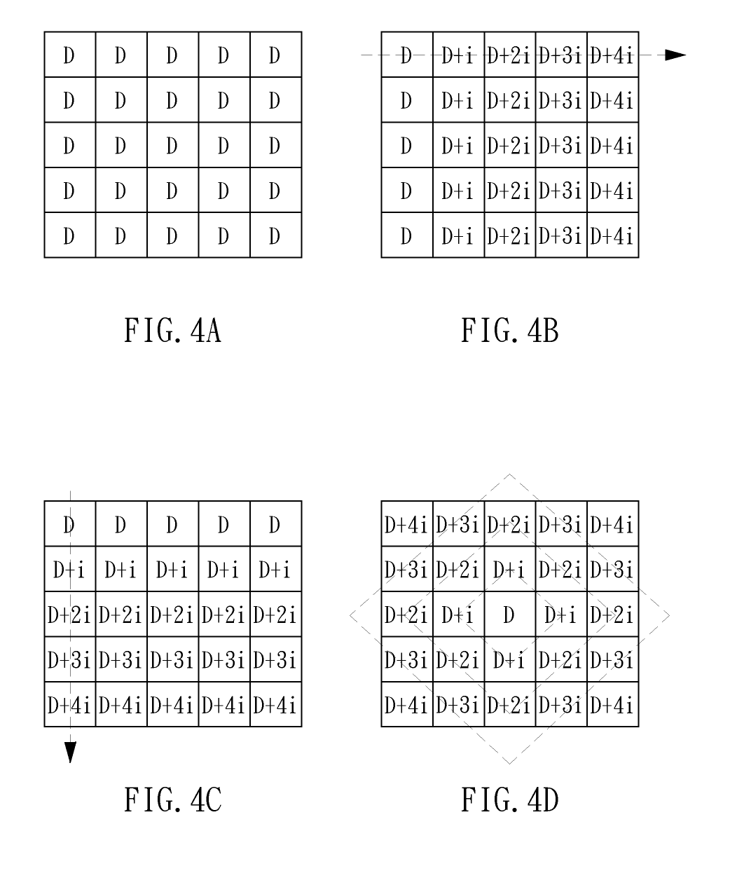

According to one aspect of the present embodiment, the OSD unit 24 further provides an OSD depth map (step 33). In the embodiment, the OSD information, which is retrieved from the command or a predetermined setting, includes spatial information and depth information. Specifically, the spatial information defines spatial characteristics, such as the shape, the size and/or the position, of each OSD region. The depth information sets the depth value within each OSD region. The OSD depth map is obtained based on spatial information and depth information. Generally speaking, the depth value of each pixel or block of pixels may be set individually. FIG. 4A through FIG. 4D show some exemplary OSD depth maps. Specifically, FIG. 4A shows a fixed-value depth map, according to which the pixels within the OSD region have the same depth value (e.g., D). FIG. 4B shows a horizontally gradient depth map, according to which the OSD region shows a gradient change (e.g., from D to D+4i) in the magnitude of the depth horizontally. FIG. 4C shows a gradient depth map similar to that of FIG. 4B except that the OSD depth map shows a gradient change (e.g., from D to D+4i) in the magnitude of the depth vertically. FIG. 4D shows a radiant depth map, according to which the depth values of the pixels within the OSD region increment (e.g., from D to D+4i) or decrement outwards.

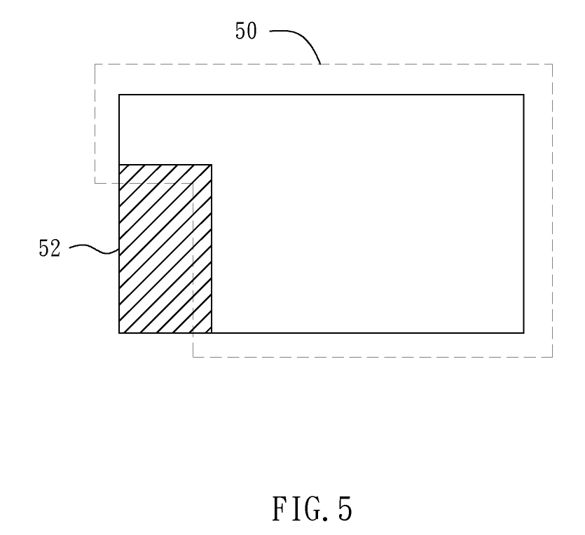

In the embodiment, each OSD region may either be globally set (in a global mode) or be set in an object-oriented manner (in an object mode). Specifically, in the global mode, the depth of each OSD region is wholly set, for example, according to the OSD depth map exemplified in FIG. 4A through FIG. 4D. In other words, each OSD region is considered as a single object. On the other hand, in the object mode, each OSD region includes a number of objects, and the depth for each object is set based on object property. FIG. 5 shows an exemplary OSD region, which includes at least two objects 50 and 52. The depth of the first object 50 is set distinctly from the depth of the second object 52. For example, when the first object 50 is activated, for example, due to being selected by a user, the first object 50 is then set with a depth larger or smaller than the depth of the second object 52.

According to a further aspect of the present embodiment, the 3D OSD imaging system 2 further includes a depth mixer 26 that receives the image depth map (from the depth generator 20) and the OSD depth map (from the OSD unit 24). The depth mixer 26 then superimposes the OSD depth map on the image depth map, therefore resulting in a composite depth map containing both the image depth and the OSD depth (step 34). Specifically speaking, the region excluding the OSD region(s) contains the image depth, and the OSD region or regions contain the OSD depth defined by the OSD depth map.

The 2D image with OSD (from the image mixer 22) and the composite depth map (from the depth mixer 26) are then fed to a depth-image-based rendering (DIBR) unit 28, which generates (or synthesizes) a left (L) image and a right (R) image according to the 2D image with OSD and the composite depth map (step 35). The left image and the right image generated from the DIBR unit 28 contain OSD image with inherently existent binocular disparity between the left image and the right image. The DIBR unit 28 may be implemented by a suitable conventional technique, for example, disclosed in a disclosure entitled “A 3D-TV Approach Using Depth-Image-Based Rendering (DIBR),” by Christoph Fehn, the disclosure of which is hereby incorporated by reference. Conceptually, as described in this disclosure, the DIBR performs the following two-step process: at first, the original image points are re-projected into a 3D space (i.e., 2D-to-3D), utilizing the respective depth data; secondly, the 3D space points are projected into an image plane or planes (i.e., 3D-to-2D), which are located at the required viewing position respectively. The DIBR unit 28 may be implemented by hardware, software or their combination. It is appreciated by those skilled in the pertinent art that the depth mixer 26 may either be individually manufactured or be integrated with the DIBR unit 28. For the latter case, the DIBR 28 receives the 2D image with OSD, the image depth map and the OSD depth map.

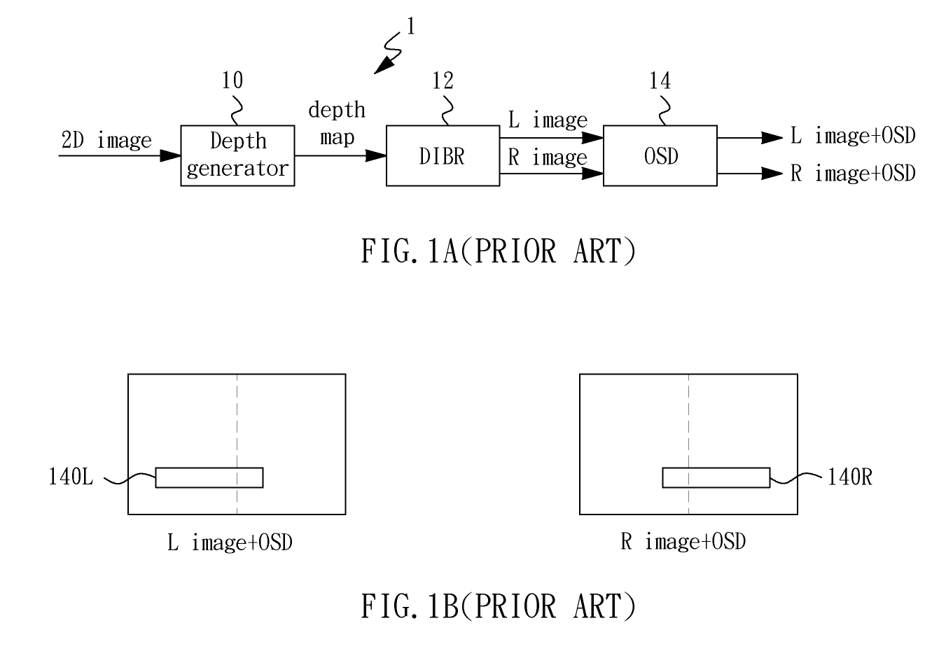

According to the embodiment described above, the resulting left image and the right image to be displayed on a 3D display may be generated in a more efficient and cost-effective way compared to the conventional 3D OSD system as shown in FIG. 1A. Moreover, the depth of the OSD region or regions according to the present embodiment is programmable and may be more flexibly set compared to the conventional 3D OSD system as shown in FIG. 1A.

Although specific embodiments have been illustrated and described, it will be appreciated by those skilled in the art that various modifications may be made without departing from the scope of the present invention, which is intended to be limited solely by the appended claims.

What is claimed is:

1. A three-dimensional (3D) on-screen display (OSD) imaging system, comprising:
a depth generator configured to generate at least one image depth map according to a two-dimensional (2D) image;
an image mixer configured to superimpose an OSD image on the 2D image, thereby resulting in a 2D image with OSD, wherein the OSD image includes at least one OSD region;
an OSD unit configured to provide an OSD depth map and the OSD image;
a depth mixer configured to superimpose the OSD depth map on the image depth map, thereby resulting in a composite depth map; and
a depth-image-based rendering (DIBR) unit configured to generate a left image and a right image according to the 2D image with OSD and the composite depth map.

2. The system of claim 1, wherein the OSD image and the OSD depth map are provided by the OSD unit whenever a command is issued.

3. The system of claim 1, wherein the OSD depth map is obtained based on spatial information that defines spatial characteristics of each said OSD region and depth information that sets a depth value on each pixel or block of pixels within each said OSD region.

4. The system of claim 3, wherein the spatial information and the depth information are retrieved from a command received by the OSD unit or a predetermined setting.

5. The system of claim 3, wherein the depth values in the OSD region are a fixed value.

6. The system of claim 3, wherein the depth values in the OSD region have a gradient change in magnitude horizontally or vertically.

7. The system of claim 3, wherein the depth values in the OSD region increment or decrement outwards.

8. The system of claim 1, wherein each said OSD region is globally set such that depth of each said OSD region is wholly set according to the OSD depth.

9. The system of claim 1, wherein each said OSD region includes a plurality of objects, and depth of each said object is set distinctly.

10. A three-dimensional (3D) on-screen display (OSD) imaging method, comprising:
generating at least one image depth map according to a two-dimensional (2D) image;
superimposing an OSD image on the 2D image, thereby resulting in a 2D image with OSD, wherein the OSD image includes at least one OSD region;
providing an OSD depth map;
superimposing the OSD depth map on the image depth map, thereby resulting in a composite depth map; and
generating a left image and a right image according to the 2D image with OSD and the composite depth map by depth-image-based rendering (DIBR).

11. The method of claim 10, wherein the OSD image and the OSD depth map are provided by whenever a command is issued.

12. The method of claim 10, wherein the OSD depth map is obtained based on spatial information that defines spatial characteristics of each said OSD region and depth information that sets a depth value on each pixel or block of pixels within each said OSD region.

13. The system of claim 12, wherein the spatial information and the depth information are retrieved from a command received by the OSD unit or a predetermined setting.

14. The method of claim 12, wherein the depth values in the OSD region are a fixed value.

15. The method of claim 12, wherein the depth values in the OSD region have a gradient change in magnitude horizontally or vertically.

16. The method of claim 12, wherein the depth values in the OSD region increment or decrement outwards.

17. The method of claim 10, wherein each said OSD region is globally set such that depth of each said OSD region is wholly set according to the OSD depth.

18. The method of claim 10, wherein each said OSD region includes a plurality of objects, and depth of each said object is set distinctly.
